(19) United States
(12) Patent Application Publication
(10) Pub. No.: US 2014/0346764 A1
(43) Pub. Date: Nov. 27, 2014

(54) Clipboard Case With Dry-Erase Board Writing Surface

(71) Applicant: Jungkun Lee, Edison, NJ (US)

(72) Inventor: Jungkun Lee, Edison, NJ (US)

(21) Appl. No.: 13/899,683

(22) Filed: May 22, 2013

(51) Int. Cl. B43L 3/00

(52) U.S. Cl. CPC B43L 3/005
USPC 281/45

(57) ABSTRACT

A clipboard case having an interior compartment, a top writing surface, which top writing surface includes a dry-erase board. The clipboard case combines the functions of a clipboard with those of a paper-carrying case and a white board writing surface. The clipboard case is hinged along its left side to allow a user to open it and access interior compartment for storage and has a latch for closure. At the back of the top surface may be situated a spring-loaded clip assembly for retaining papers on the top writing surface. In one embodiment, a calculator is attached to the clip assembly. The top writing surface includes a non-porous, dry erase surface, also known as a whiteboard which may be recessed into the top writing surface thereby making it flush with the top surface. The whiteboard is utilized to write upon using a dry erase pen.

### FIELD OF THE INVENTION

The present invention is a clipboard case or storage box presenting a writing surface and a compartment for retaining papers. More specifically, the present invention clipboard includes a dry erase board on its top writing surface.

### BACKGROUND OF THE INVENTION

The present invention is a clipboard case having an interior compartment and a writing surface on its top which top writing surface includes a dry-erase writing surface. Clipboards are well known in the prior art. Typically, clipboards have a top surface which presents a surface for writing. In prior art clipboards, there is often a clip assembly near the top of the writing surface, the clip assembly employed to retain papers flat against the writing surface. The clip assembly is typically spring-loaded, i.e. the spring presses the forward edge of the clip assembly down to retain the papers against the writing surface. By exerting pressure on the back edge of the clip assembly, the front of the assembly is lifted up away from the writing surface thereby permitting a user to remove the paper or stack of papers from the clipboard.

Improvements to the basic prior-art clipboard are known. For example, U.S. Pat. No. 7,465,057 B2 shows a typical basic prior art clipboard with the added improvement of a reading light. Another example is shown in U.S. Pat. No. D388,463 which shows a design for a clipboard with a padded writing surface.

There are also clipboard cases which hold papers in their interiors in the prior art. One example is US Design Pat. D492,358 S, owned by the assignee herein, for a clipboard storage box having clip assembly on its top surface. Another example is US Design Pat. D495,746 S, owned by the assignee herein, for a clipboard storage box including a clip assembly and carrying handle.

However, none of the prior art shows the novel and non-obvious combination of elements shown in the present invention as shown and claimed herein. None of the prior art shows a combination of a clipboard presenting a writing surface, a clip assembly, an interior compartment and a dry erase writing surface on its top surface.

Other objectives, advantages and novel features, and further scope of applicability of the present invention will be set forth in the detailed description to follow, taken in conjunction with the accompanying drawings, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a clipboard case having an interior compartment, a top writing surface, which top writing surface includes a dry-erase board. The clipboard case of the present invention combines the functions of a clipboard with those of a paper-carrying case and provides a white board writing surface as well. As such, a portable writing surface is provided. The clipboard case is hinged along its left side to allow a user to open it and to gain access to the interior compartment for storage therein. The interior compartment is employed for holding papers, pens and the like. A latch for closure is located on the left side. At the back of the top surface may be situated a spring-loaded clip assembly for retaining papers on the top writing surface. In one embodiment, a calculator is attached to the clip assembly. The top writing surface includes a non-porous, dry erase surface, also known as a whiteboard. The whiteboard may be recessed into the top writing surface thereby making it flush with the balance of the top surface. The whiteboard is utilized to write upon using a dry erase pen, which has ink that can readily be erased thereby allowing the writer to re-write alternate writing.

### BRIEF DESCRIPTION OF THE FIGURES

For a better understanding of the present invention, reference is made to the following description of an exemplary embodiment thereof, considered in conjunction with the accompanying drawings, in which:

FIG. 1 is a front prospective view of a preferred embodiment of the present invention clipboard case with dry-erase writing surface and having a clip assembly.

FIG. 1A is a front prospective view of a second embodiment of the present invention clipboard case with dry-erase writing surface and not having a clip assembly.

FIG. 1B is a front prospective view of a third embodiment of the present invention clipboard case with dry-erase writing surface and having a calculator attached to its clip assembly.

FIG. 2 is a top view of the present invention clipboard case with dry-erase writing surface.

FIG. 3 is a bottom view of the present invention clipboard case with dry-erase writing surface.

FIG. 4 is front view of the present invention clipboard case with dry-erase writing surface.

FIG. 5 is a back view of the present invention clipboard case with dry-erase writing surface.

FIG. 6 is a right side view of the present invention clipboard case with dry-erase writing surface.

FIG. 7 is a left side view of the present invention clipboard case with dry-erase writing surface.

FIG. 8 is a front perspective view of the present invention clipboard case with dry-erase writing surface showing the interior compartment.

### DETAILED DESCRIPTION OF THE INVENTION

The present invention is a clipboard case having a top writing surface upon which writing on paper can be accomplished, which clipboard case includes a compartment for retaining papers, pens and the like. Furthermore, the present invention clipboard includes a dry erase board on its top writing surface. The clipboard case of the present invention combines the functions of a clipboard with those of a paper-carrying case and provides a white board writing surface as well. As such, a portable writing surface is provided. Thus, a user is enabled to carry around the portable writing surface of the clipboard case, thereby providing functionality and convenience.

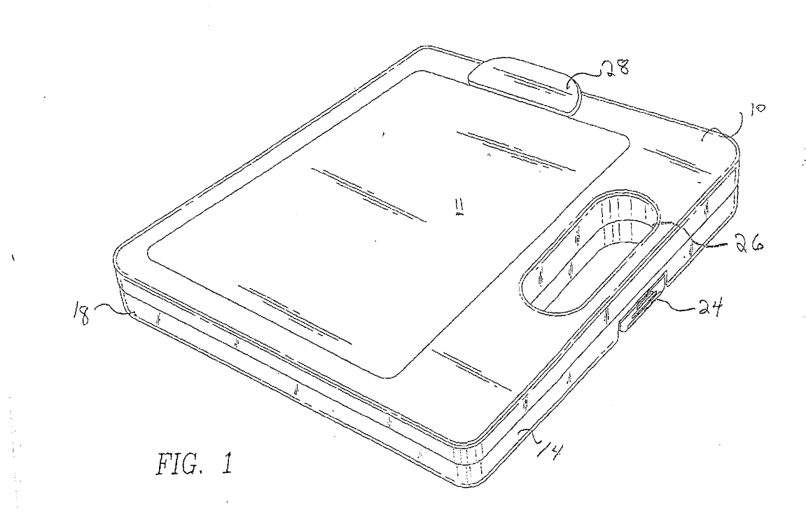

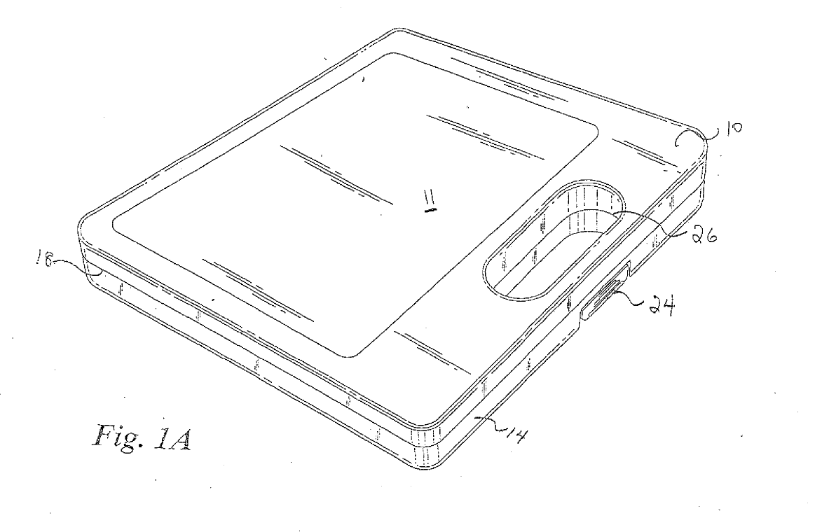

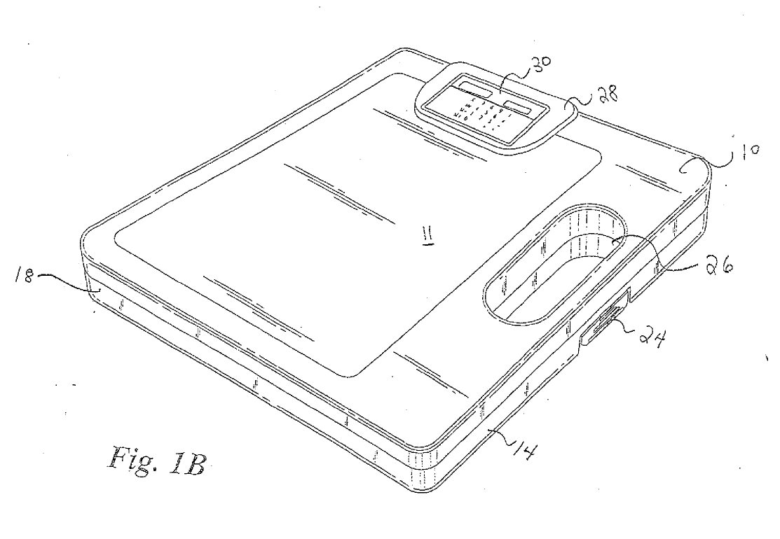

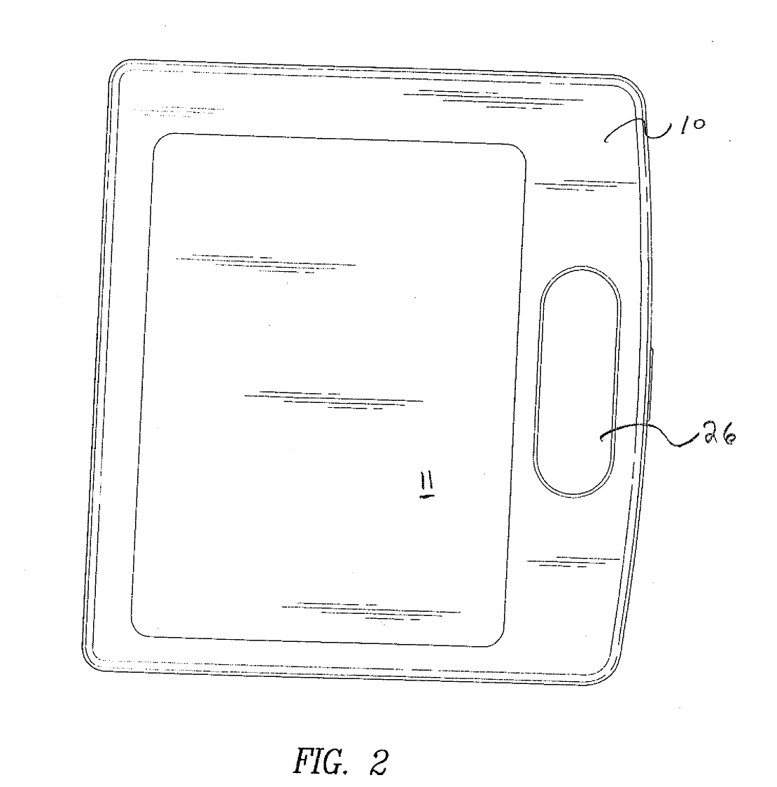

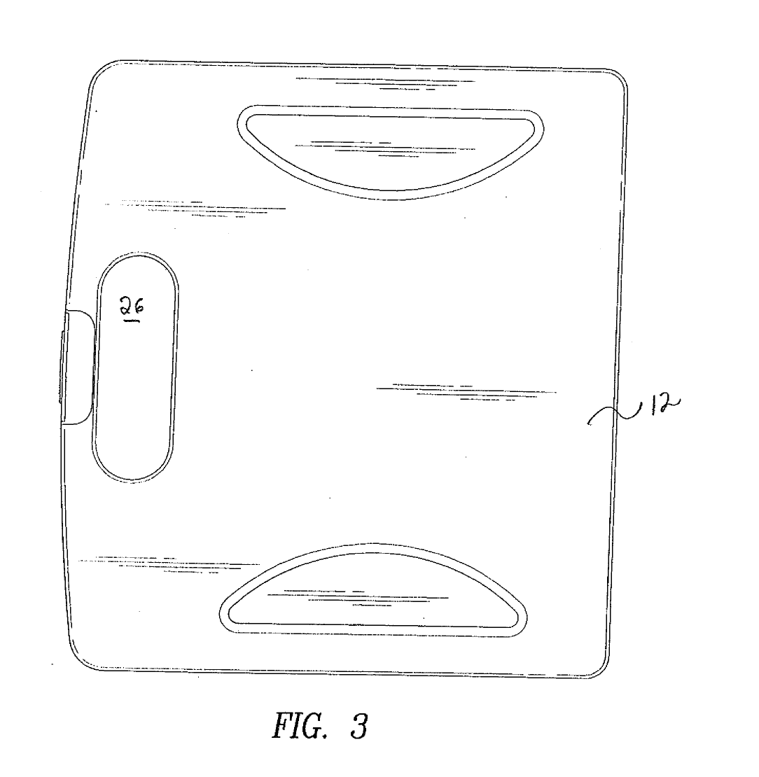

Looking now at the Figures, the present invention clipboard case is depicted in various embodiments. Looking at FIG. 1, the clipboard case of the present invention is molded from plastic or other such rigid material and has a top surface 10. On the top surface is a flat writing surface, which is the present invention is improved by including a whiteboard surface 11 (also known as a dry-erase board.) Looking more closely at the Figures, the clipboard case of the present invention is formed into the shape of a flat container or box which opens up to reveal a compartment inside employed for paper, pen or other such storage. The clipboard case of the present invention has six exterior surfaces denoted as follows: top surface 10, bottom surface 12, right side 14, left side 16, front 18, and back 20. The top surface, the bottom surface and the side, front and back surfaces define an interior compartment, said interior compartment sized for and utilized to retain papers, pens or the like.

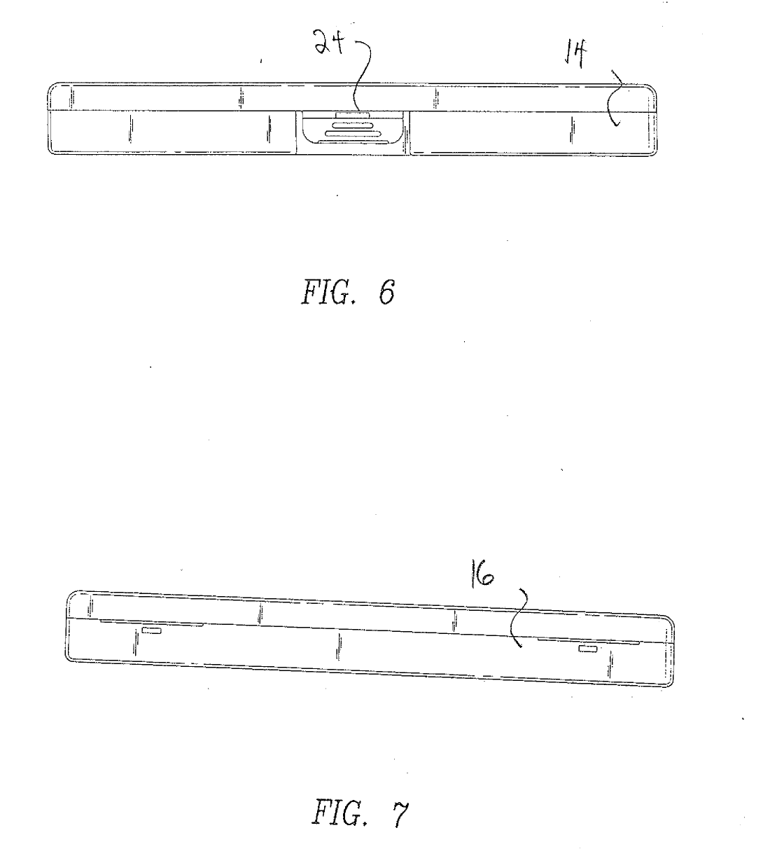

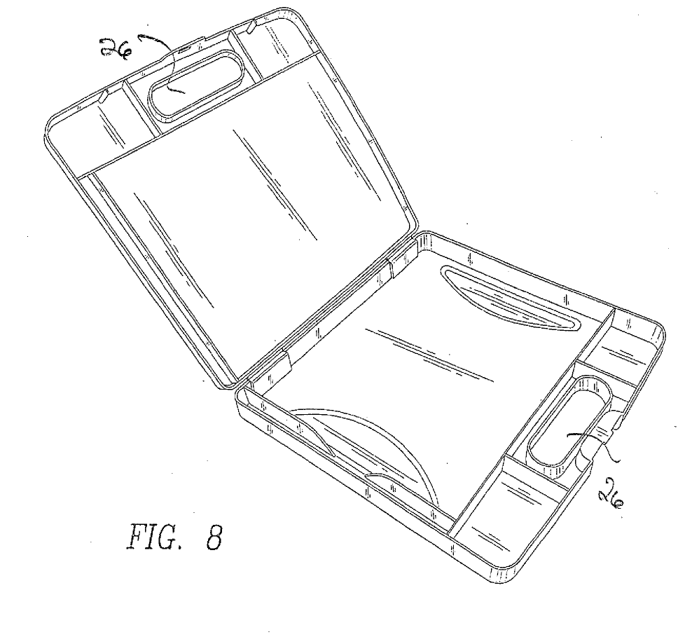

As can be seen best in the left side view of FIG. 7, hinges 22 are located on the left side of the box. The hinges attach the top to the bottom along the left side of the box and permit the opening and closing of the box.

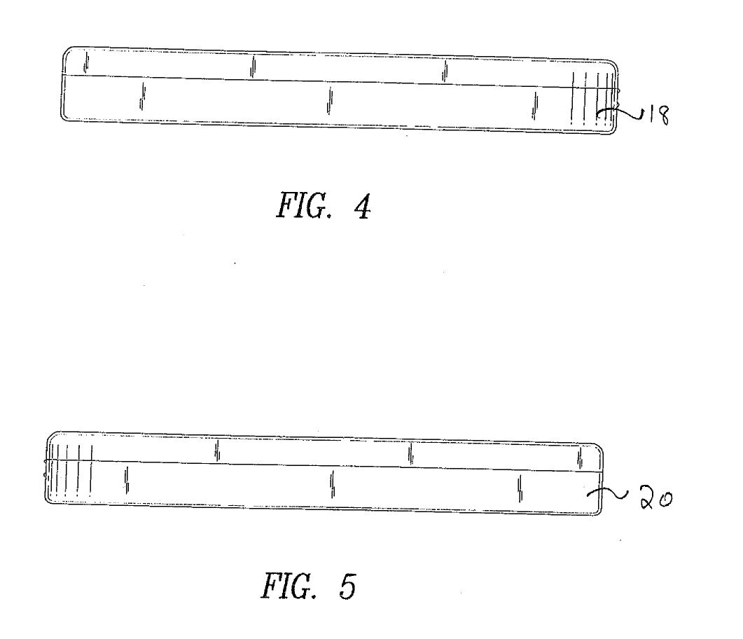

A latch 24 is located on the right side of the case as seen best in FIG. 6. When the case is in its closed configuration, the latch keeps the case closed. Through deformation of the tongue of the latch, the case is unlatched and permitted to open.

Furthermore, a handle 26 is formed into the plastic of both the top and the bottom. Specifically, the handle perforates the top and the bottom to create a cavity sized for a human hand thereby forming the handle of the present invention as seen in the figures.

Attached to the top surface in a preferred embodiment, near the back of the clipboard case, is a clip assembly 28. The clip assembly is utilized to retain a page of paper or a stack of papers to the top of the clipboard. The clip assembly includes springs or tension elements to keep the forward edge of the clip assembly tensioned against the top surface of the clipboard until pressure is exerted onto the rear edge of the clip assembly. Once pressure is exerted onto the rear edge of the clip assembly, the forward edge is caused to elevate, thereby releasing the paper or papers from the clip.

Alternative embodiments of the present invention are depicted in FIGS. 1A and 1B. In FIG. 1A, the invention is shown without the clip assembly. In this embodiment of the invention, the clipboard has the interior compartment and the top flat writing surface which is a dry-erase board. In the embodiment shown in FIG. 1B, the invention has a calculator 30 attached to the clip assembly.

Looking more closely at the top surface of the embodiment shown of the present invention, it can be seen that the dry-erase board 11 covers most, but not all, of the top surface. Furthermore, the dry-erase (whiteboard surface) may be recessed into the top surface of the clip. Specifically, and as shown, because it is partially recessed into the top surface, the dry-erase surface sits substantially flush with the rest of the top surface of the clipboard case. As is known, the whiteboard of the present invention is formed from a non-porous material that will not absorb ink from writing thereupon. Typically, as is suggested by its name, the color of the whiteboard is white, although it need not be. Moreover, in addition to being white and non-porous, the whiteboard of the present invention should have a glossy, non-absorbent surface. The whiteboard of the present invention may be manufactured from Melamine (a resin-infused paper), painted steel or aluminum, laminate or porcelain enamel on steel.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

What is claimed:

1. A clipboard case for retaining sheets of paper comprising:
a container formed from a rigid material having a top surface, a bottom surface, a front and back surface and two side surfaces, said container having an interior compartment defined by the top, bottom, front, back and side surfaces;
a flat writing area on the top surface of the container;
a clip assembly attached to said top surface of said clipboard, said clip assembly having a forward edge, said clip assembly utilized to retain sheets of paper to the top surface, and having tensioning means to retain and release the sheets of paper; and
wherein said flat writing surface on said top surface includes a dry-erase board, said dry-erase board sitting flush with the flat writing surface.

2. A clipboard case for retaining sheets of paper comprising:
a container formed from a rigid material having a top surface, a bottom surface, a front and back surface and two side surfaces, said container having an interior compartment defined by the top, bottom, front, back and side surfaces;
a flat writing area on the top surface of the container; and
wherein said flat writing surface on said top surface includes a dry-erase board, said dry-erase board sitting flush with the flat writing surface.

3. The clipboard case of claim 1 wherein said clip assembly includes a calculator.
